(19) United States
(12) Patent Application Publication
(10) Pub. No.: US 2012/0060094 A1
(43) Pub. Date: Mar. 8, 2012

(54) SYSTEM AND METHOD FOR DISPLAYING INFORMATION RELATED TO VIDEO PROGRAMS IN A GRAPHICAL USER INTERFACE

(76) Inventors: Jane Irwin, San Francisco, CA (US); Crx K. Chai, Oakland, CA (US); Alex Fishman, San Francisco, CA (US)

(21) Appl. No.: 12/877,993

(22) Filed: Sep. 8, 2010

(51) Int. Cl. G06F 3/048

(52) U.S. Cl. 715/719

(57) ABSTRACT

A system and method for displaying information relating to video programs in a graphical user interface. Real-time data for video programs are received from a plurality of data sources. A real-time popularity metric for each video program is determined based on the real-time data. For at least a subset of the video programs, a respective graphical user interface object that corresponds to at least one respective video program in the subset of the video programs is displayed based on a respective real-time popularity metric for the at least one respective video program, wherein a location at which the respective graphical user interface object is displayed in the graphical user interface relative to other graphical user interface objects and a visual appearance of the respective graphical user interface object relative to other graphical user interface objects indicate the popularity of the at least one respective video program relative to other video programs.

### RELATED APPLICATIONS

This application is related to U.S. patent application Ser. No. 12/877,034 (Attorney Docket Number 2050.171US1), by Crx Chai and Alex Fishman, entitled “Smart Playlist” and filed Sep. 7, 2010, which application is incorporated by reference herein in its entirety. This application is also related to U.S. patent application Ser. No. ______ (Attorney Docket Number 2050.175US1), by Crx Chai and Alex Fishman, entitled “Collecting Data From Multiple Sources” and filed Sep. 8, 2010, which application is incorporated by reference herein in its entirety.

### TECHNICAL FIELD

The disclosed embodiments relate generally to a graphical user interface and methods for displaying information related to video programs.

### BACKGROUND

Electronic program guides for television programs present currently available video programs (e.g., television programs, movies, etc.) in a grid format in which a first axis includes time blocks (e.g., half-hour time blocks) and a second axis includes a list of channels. Graphical user interface objects (e.g., blocks with text) displayed at the intersection of the two axes typically correspond to an available video program. Electronic program guides are manageable when the number of channels is small. However, satellite television and cable television offer hundreds of channels. Thus, when browsing for a video program airing on satellite television or cable television, an end user must undertake the tedious process of scrolling through a substantial portion of the hundreds of channels in the electronic program guide to locate a television program to view. With the addition of online video sources (e.g., YouTube, video streaming services, video download services, etc.), the number of number of video programs currently available to an end user is large and the end user's task of locating a desired video program to view becomes more difficult. Thus, it is highly desirable to provide a system and method for displaying information relating to video programs without the aforementioned problems.

### BRIEF DESCRIPTION OF THE DRAWINGS

FIG. 1A is a block diagram illustrating a graphical user interface for displaying information relating to video programs, according to some embodiments.

FIG. 1B is another block diagram illustrating the graphical user interface for displaying information relating to video programs, according to some embodiments.

FIG. 1C is another block diagram illustrating the graphical user interface for displaying information relating to video programs, according to some embodiments.

FIG. 1D is another block diagram illustrating the graphical user interface for displaying information relating to video programs, according to some embodiments.

FIG. 1E is another block diagram illustrating the graphical user interface for displaying information relating to video programs, according to some embodiments.

FIG. 1F is another block diagram illustrating the graphical user interface for displaying information relating to video programs, according to some embodiments.

FIG. 1H is another block diagram illustrating the graphical user interface for displaying information relating to video programs, according to some embodiments.

FIG. 11 is another block diagram illustrating the graphical user interface for displaying information relating to video programs, according to some embodiments.

FIG. 2A is a block diagram illustrating a graphical user interface for displaying information relating to video programs, according to some embodiments.

FIG. 2B is another block diagram illustrating the graphical user interface for displaying information relating to video programs, according to some embodiments.

FIG. 2C is another block diagram illustrating the graphical user interface for displaying information relating to video programs, according to some embodiments.

FIG. 2D is another block diagram illustrating the graphical user interface for displaying information relating to video programs, according to some embodiments.

FIG. 3 is a block diagram illustrating data sources that provide information relating to video programs, according to some embodiments.

FIG. 4 is a block diagram illustrating a computer system for displaying information relating to video programs in a graphical user interface, according to some embodiments.

FIG. 5 is a flowchart of a method for displaying information relating to video programs in a graphical user interface, according to some embodiments.

FIG. 6 is a flowchart of a method for displaying information relating reasons why a selected video program has a particular popularity metric, according to some embodiments.

FIG. 7 is a flowchart of a method for displaying detailed information relating a selected video program, according to some embodiments.

FIG. 8 is a flowchart of a method for playing a selected video program, according to some embodiments.

FIG. 9 is a flowchart of a method for recording a selected video program, according to some embodiments.

FIG. 10 is a flowchart of a method for displaying video programs related to a selected video program, according to some embodiments.

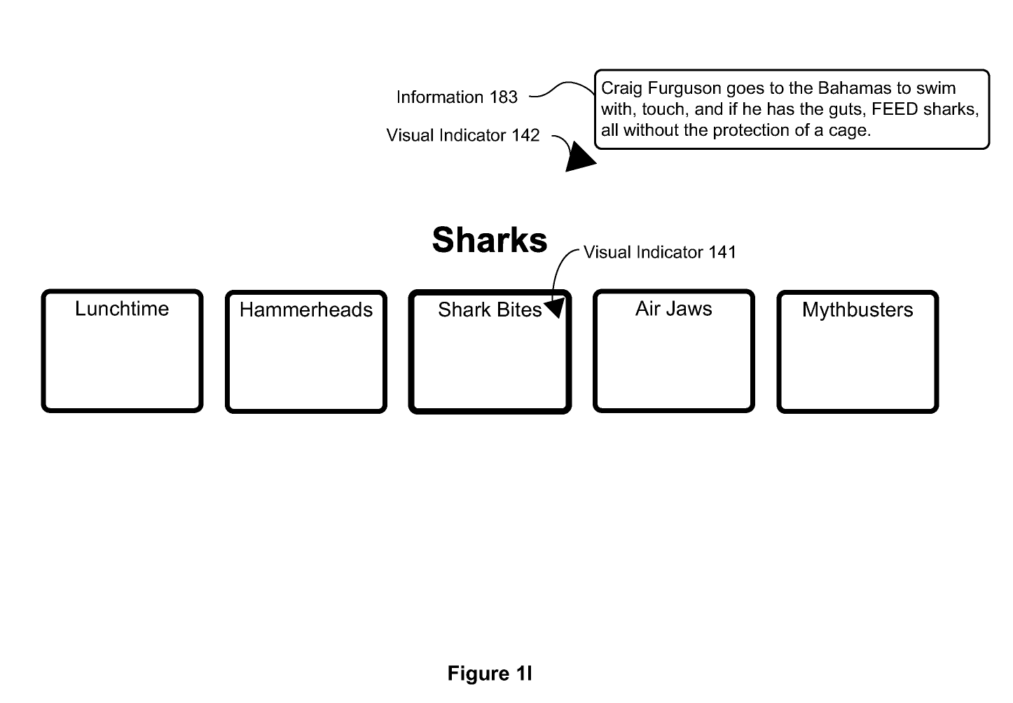

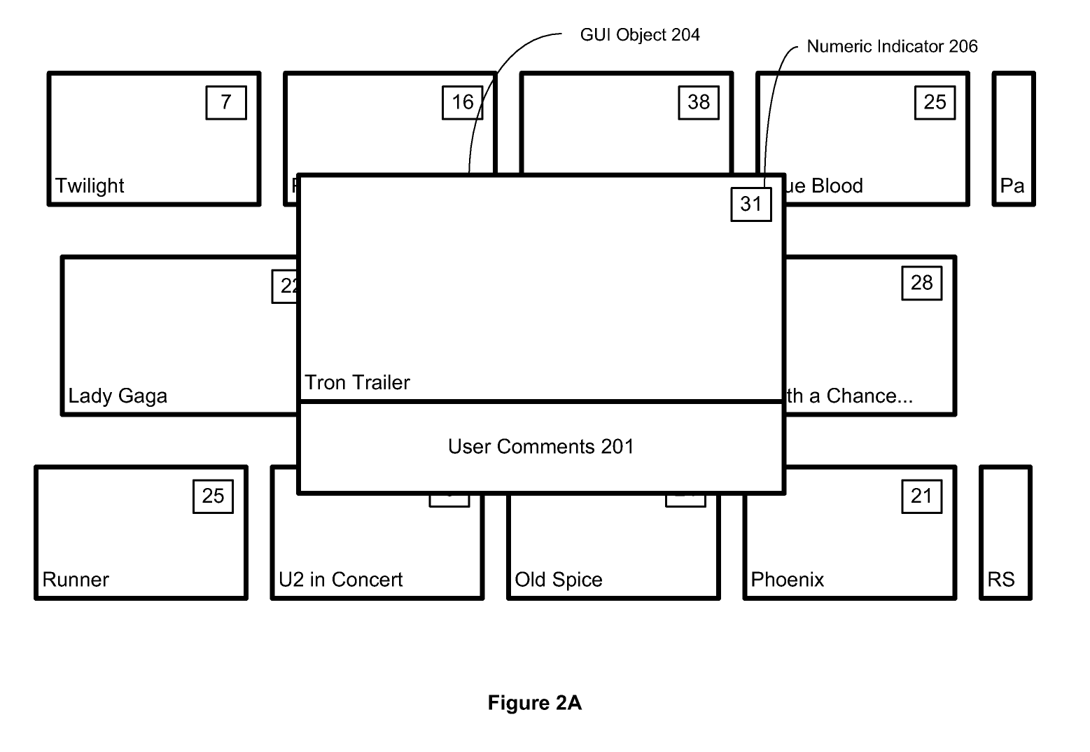

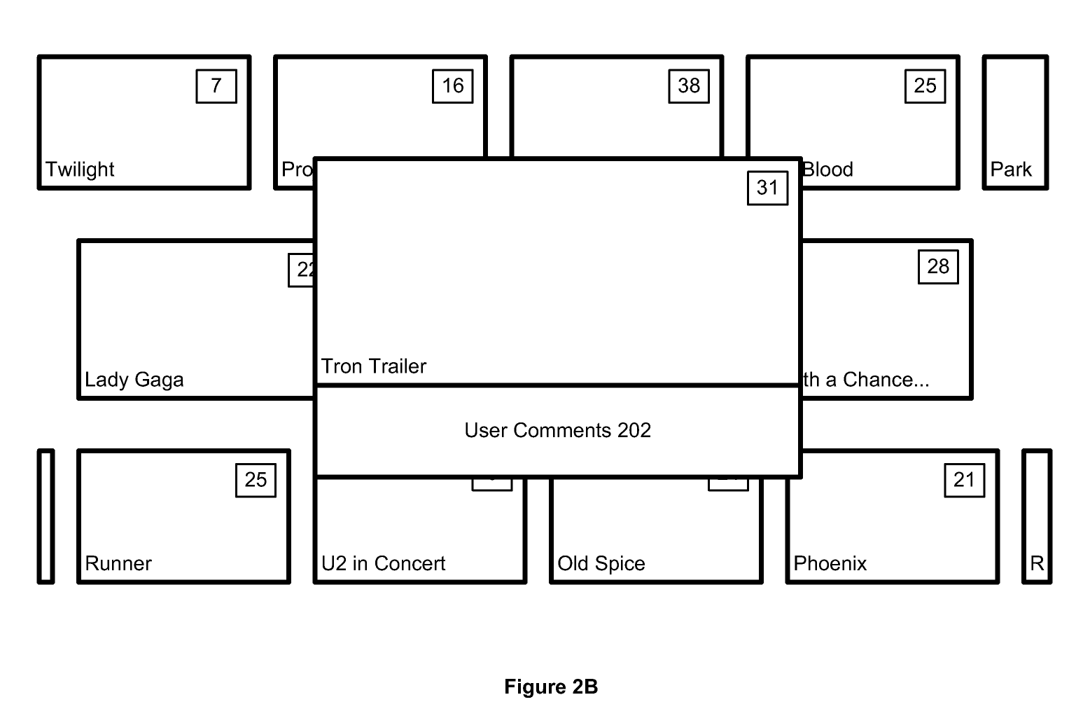

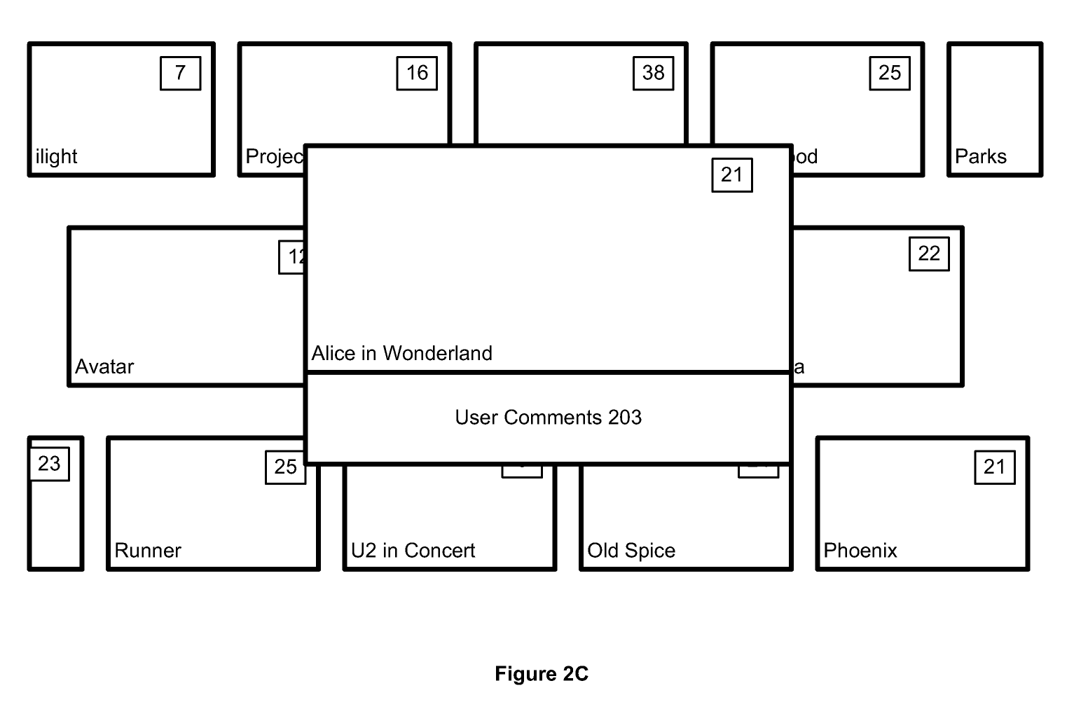

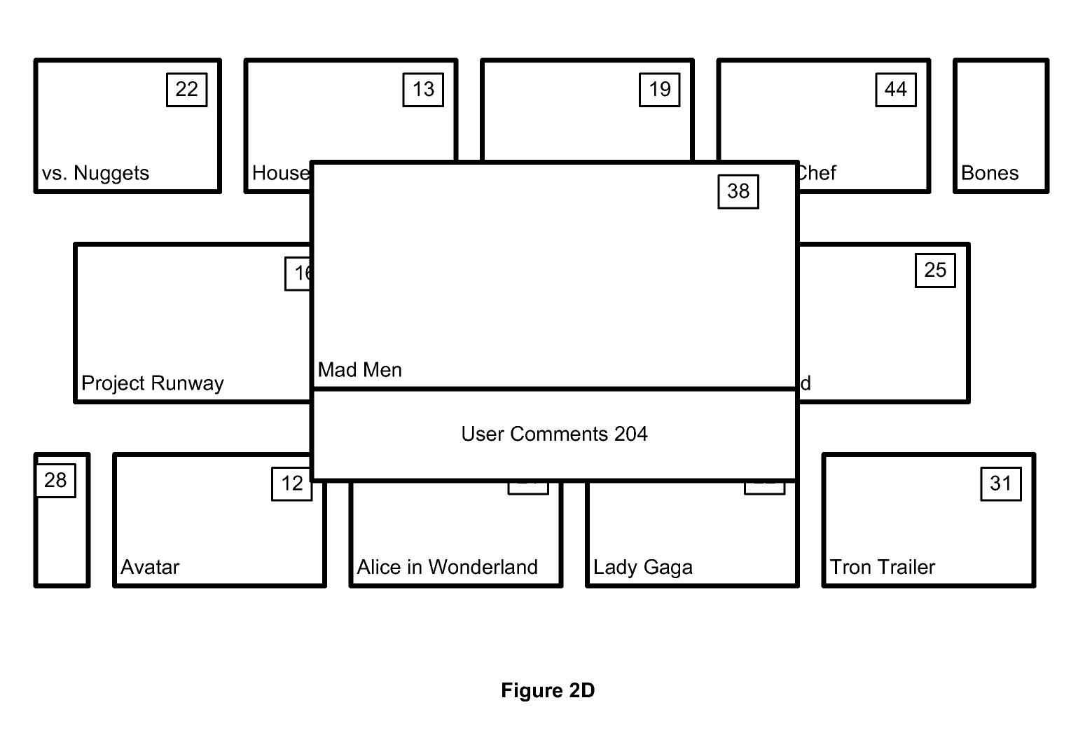

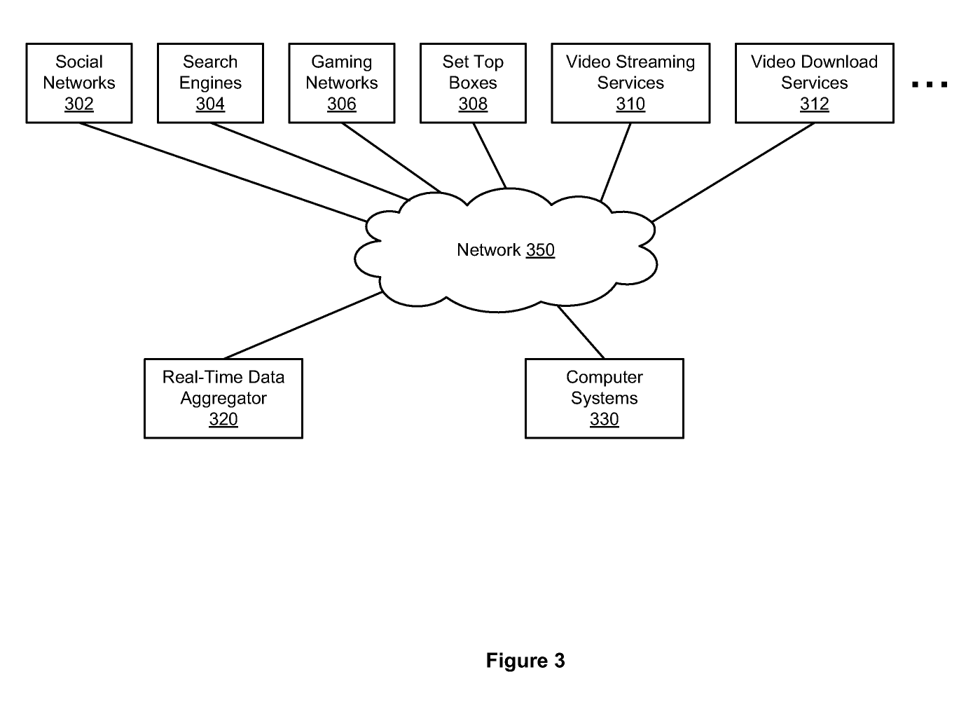

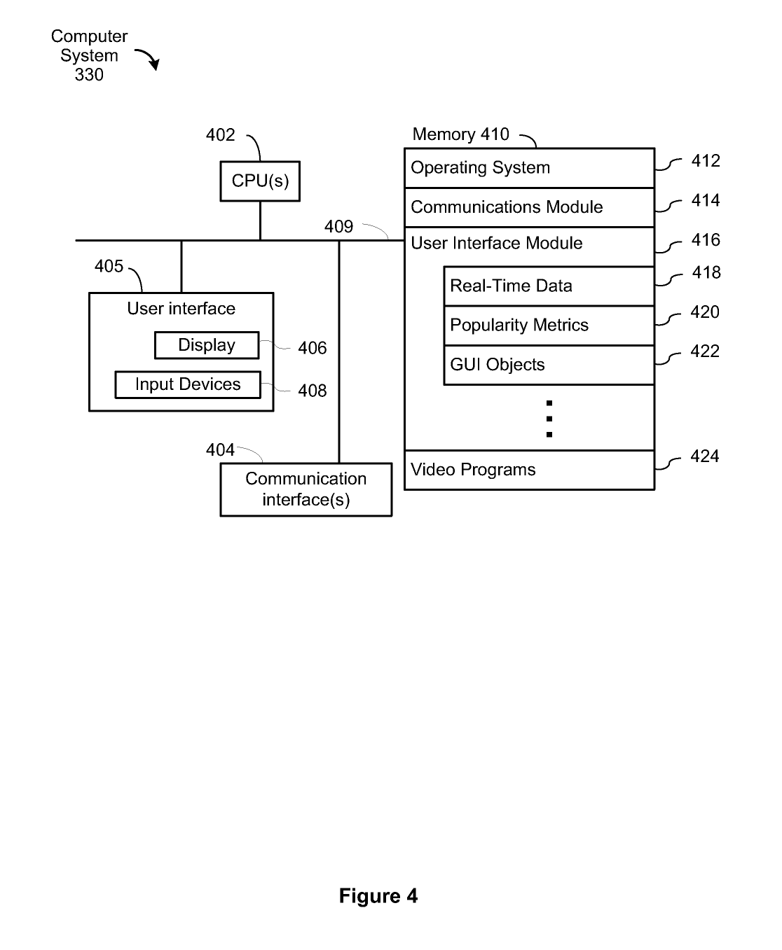

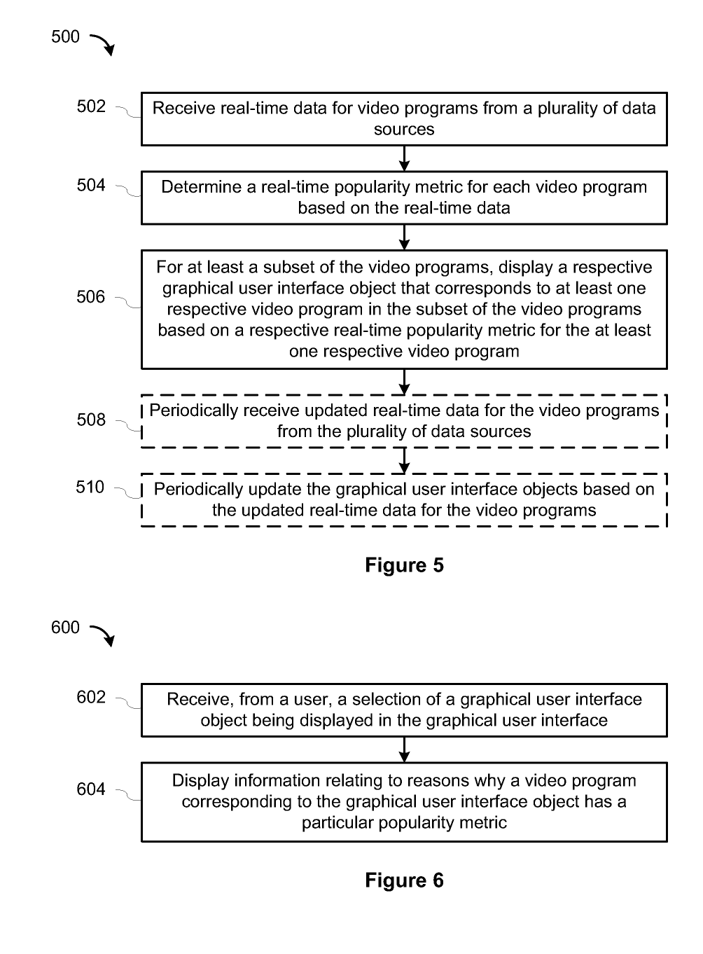

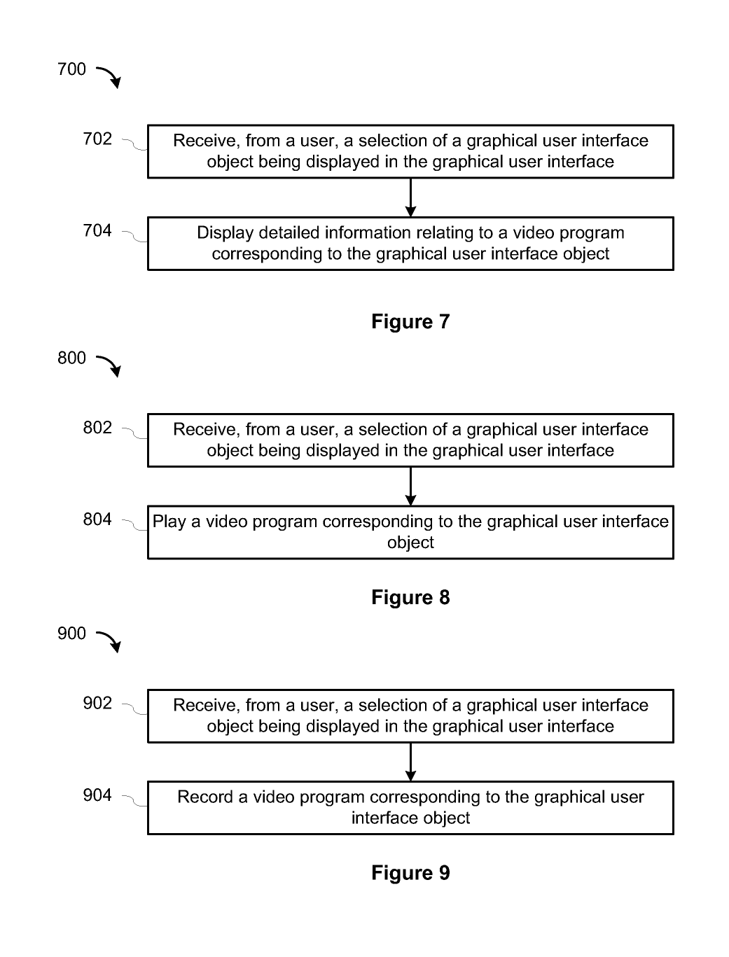

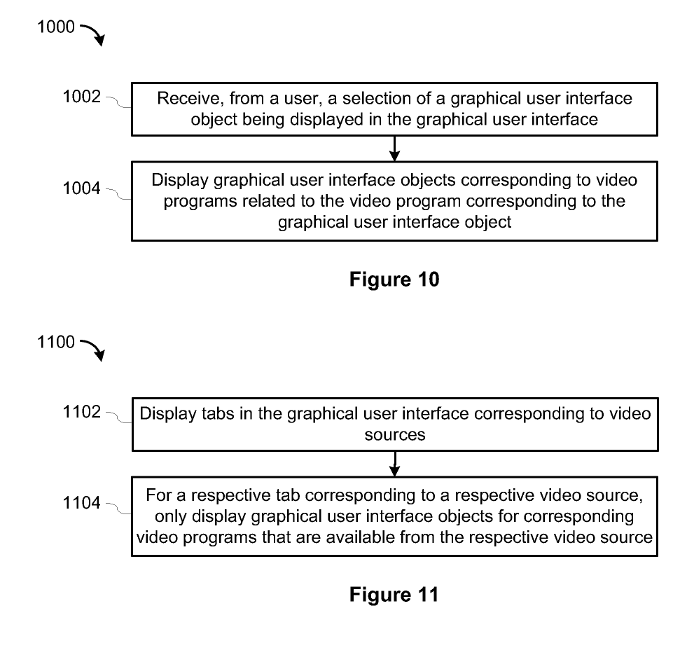

FIG. 11 is a flowchart of a method for displaying video programs from a particular video source, according to some embodiments.

Like reference numerals refer to corresponding parts throughout the drawings.

### DESCRIPTION OF EMBODIMENTS

### Overview

A system, a computer-readable storage medium including instructions, and computer-implemented method for displaying information relating to video programs in a graphical user interface is provided. Real-time data for video programs are received from a plurality of data sources. A real-time popularity metric for each video program is determined based on the real-time data. For at least a subset of the video programs, a respective graphical user interface object that corresponds to at least one respective video program in the subset of the video programs is displayed based on a respective real-time popularity metric for the at least one respective video program, wherein a location at which the respective graphical user interface object is displayed in the graphical user interface relative to other graphical user interface objects and a visual appearance of the respective graphical user interface object relative to other graphical user interface objects indicate the popularity of the at least one respective video program relative to other video programs.

In some embodiments, the visual appearance of the respective graphical user interface object includes a size of the respective graphical user interface object relative to other graphical user interface objects.

In some embodiments, when the respective graphical user interface object for the at least one respective video program is larger than a second graphical user interface object corresponding to a second video program, the at least one respective video program is more popular than the second video program.

In some embodiments, the visual appearance of the respective graphical user interface object includes an amount that the respective graphical user interface object is in focus.

In some embodiments, when the respective graphical user interface object for the at least one respective video program is more in focus than a second graphical user interface object corresponding to a second video program, the at least one respective video program is more popular than the second video program.

In some embodiments, the location of the respective graphical user interface object includes a perceived distance that the respective graphical user interface object is from a user.

In some embodiments, when the respective graphical user interface object for the at least one respective video program is perceived to be closer to the user than a second graphical user interface object corresponding to a second video program, the at least one respective video program is more popular than the second video program.

In some embodiments, the location of the respective graphical user interface object includes a distance that the respective graphical user interface object is from a center of the graphical user interface.

In some embodiments, when the respective graphical user interface object for the at least one respective video program is closer to the center of the graphical user interface than a second graphical user interface object corresponding to a second video program, the at least one respective video program is more popular than the second video program.

In some embodiments, the visual appearance of the respective graphical user interface object includes a numeric indicator corresponding to the popularity of the at least one respective video program relative to other video programs.

In some embodiments, when the respective graphical user interface object for the respective program includes a numeric indicator that is larger in value than a number indicator for a second graphical user interface object corresponding to a second video program, the at least one respective video program is more popular than the second video program.

In some embodiments, updated real-time data for the video programs from the plurality of data sources are periodically received and the graphical user interface objects are periodically updated based on the updated real-time data for the video programs.

In some embodiments, a video program is selected from the group consisting of: a movie, a movie trailer, a television show, a commercial, a music video, and an animation.

In some embodiments, a data source is selected from the group consisting of: a social network, a gaming network, a search engine, a set top box, a video streaming service, and video download service.

In some embodiments, a selection of a graphical user interface object being displayed in the graphical user interface is received from a user and information relating to reasons why a video program corresponding to the graphical user interface object has a particular popularity metric is displayed.

In some embodiments, a selection of a graphical user interface object being displayed in the graphical user interface is received from a user and detailed information relating to a video program corresponding to the graphical user interface object is displayed.

In some embodiments, a selection of a graphical user interface object being displayed in the graphical user interface is received from a user and a video program corresponding to the graphical user interface object is played.

In some embodiments, a selection of a graphical user interface object being displayed in the graphical user interface is received from a user and a video program corresponding to the graphical user interface object is recorded.

In some embodiments, a selection of a graphical user interface object being displayed in the graphical user interface is received from a user and graphical user interface objects corresponding to video programs related to the video program corresponding to the graphical user interface object are displayed.

In some embodiments, tabs are displayed in the graphical user interface corresponding to video sources. For a respective tab corresponding to a respective video source, only graphical user interface objects for corresponding video programs that are available from the respective video source are displayed.

In some embodiments, the respective video source is selected from the group consisting of: a cable television video feed, a satellite television video feed, an over-the-air television video feed, and an Internet video feed.

Some embodiments provide a graphical user interface on a computer system including at least one processor and memory storing at least one program, the at least one processors configured to execute the at least one program. The graphical user interface includes a plurality of graphical user interface objects displayed in the graphical user interface of the computer system, wherein a respective graphical user interface object corresponds to at least one respective video program, wherein a location at which the respective graphical user interface object is displayed in the graphical user interface relative to other graphical user interface objects and a visual appearance of the respective graphical user interface object relative to other graphical user interface objects is based on a popularity metric that indicates the popularity of the at least one respective video program relative to other video programs, wherein the popularity metric of the at least one respective video program is determined from real-time data for the video programs that are received from plurality of data sources.

Some embodiments provide a system, a computer-readable storage medium including instructions, and computer-implemented method for displaying information relating to media objects in a graphical user interface. Real-time data for media objects from a plurality of data sources are received. A real-time popularity metric for each media object is determined based on the real-time data. For at least a subset of the media objects, a respective graphical user interface object that corresponds to at least one respective media object in the subset of the media objects is displayed based on a respective real-time popularity metric for the at least one respective media object, wherein a location at which the respective graphical user interface object is displayed in the graphical user interface relative to other graphical user interface objects and a visual appearance of the respective graphical user interface object relative to other graphical user interface objects indicate the popularity of the at least one respective media object relative to other media objects.

In some embodiments, the at least one respective media object is selected from the group consisting of: video, audio, text, and an image.

Some embodiments provide a graphical user interface on a computer system including at least one processor and memory storing at least one program, the at least one processors configured to execute the at least one program. The graphical user interface includes a plurality of graphical user interface objects displayed in the graphical user interface of the computer system, wherein a respective graphical user interface object corresponds to at least one respective media object, wherein a location at which the respective graphical user interface object is displayed in the graphical user interface relative to other graphical user interface objects and a visual appearance of the respective graphical user interface object relative to other graphical user interface objects is based on a popularity metric that indicates the popularity of the at least one respective media object relative to other media objects, wherein the popularity metric of the at least one respective media object is determined from real-time data for the media objects that are received from plurality of data sources.

### Graphical User Interface

As discussed above, existing techniques for displaying information relating to video programs places the burden of identifying video programs that a user may be interested in viewing on the user. To address this problem, some embodiments provide a system, method, graphical user interface for displaying information relating to video programs. In these embodiments, the information relating to the video programs is displayed in a manner in which the user can quickly identify video programs that the user may be interested in viewing. In some embodiments, the information relating to the video programs is displayed so that the relative real-time popularity of video programs is easily identifiable. In doing so, a user can quickly navigate to a video program that is currently popular.

In some embodiments, the popularity of video programs is determined based on real-time data for video programs that are received from a plurality of data sources. In some embodiments, the plurality of data sources includes a social network. In these embodiments, the real-time data includes data obtained from status updates for users of the social network, video programs being discussed between users of the social network, video programs being shared between users of the social network, and links to video programs being shared between users of the social network.

In some embodiments, the plurality of data sources includes a gaming network. In these embodiments, the real-time data includes data obtained from conversations between users of the gaming network and status updates posted by users of the gaming network.

In some embodiments, the plurality of data sources includes a search engine. In these embodiments, the real-time data includes search engine statistics related to video programs being searched by users of the search engine. The search engine statistics may include the number of search results that include video programs, the number of search results that include keywords associated with video programs, search terms associated with video programs, times at which the searches were performed, and the like.

In some embodiments, the plurality of data sources includes set top boxes. In these embodiments, the real-time data includes data relating to video programs being currently watched or recorded (or that were watched or recorded in the past) by users of the set top boxes and video programs that are being scheduled (or have been scheduled in the past) to be recorded by users of the set top boxes.

In some embodiments, the plurality of data sources includes a video streaming service. In these embodiments, the real-time data includes data relating to video programs being streamed to users of the video streaming service, video programs being searched for by users of the video streaming service, video programs being added to a video streaming queue by users of the video streaming service.

In some embodiments, the plurality of data sources includes a video download service. In these embodiments, the real-time data includes data relating to video programs being downloaded by users of the video downloading service, video programs being searched for by users of the video downloading service, video programs being added to a video download queue by users of the video downloading service.

In some embodiments, the real-time data is used to generate a popularity metric for each video program. The popularity metric is indicative of the viewers' heightened interest. The popularity metric for each video program may be used to generate graphical user interface (GUI) objects that allow a user to easily identify the real-time relative popularity of video program. Several exemplary techniques for displaying GUI objects are displayed are described below.

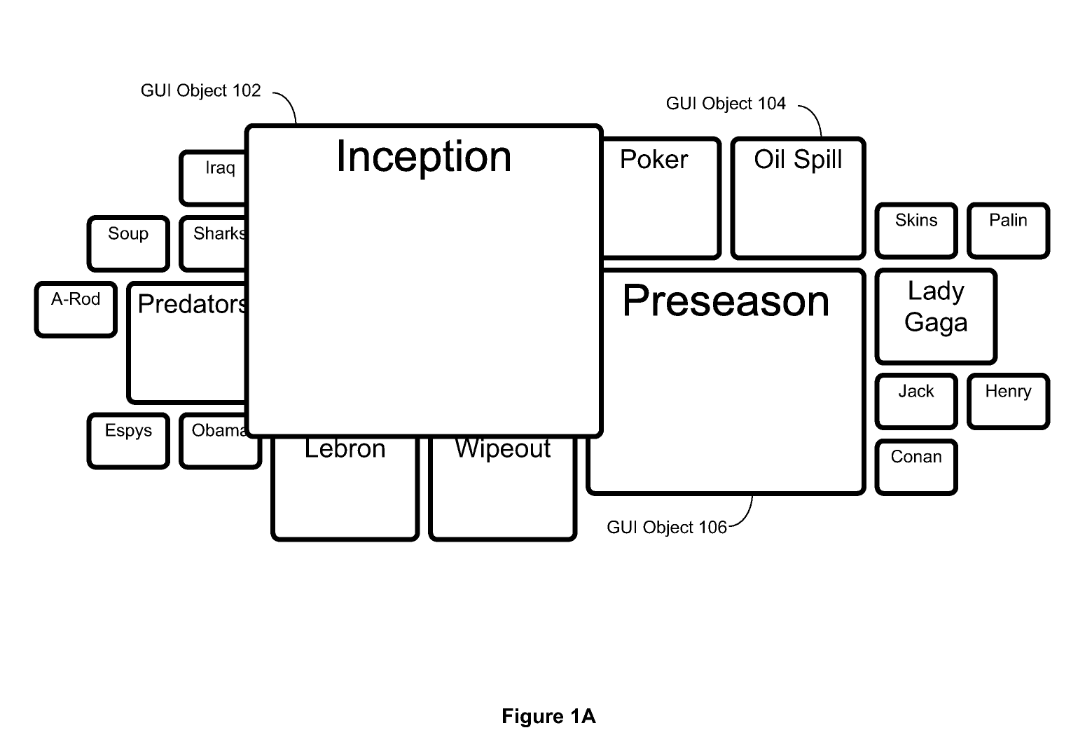

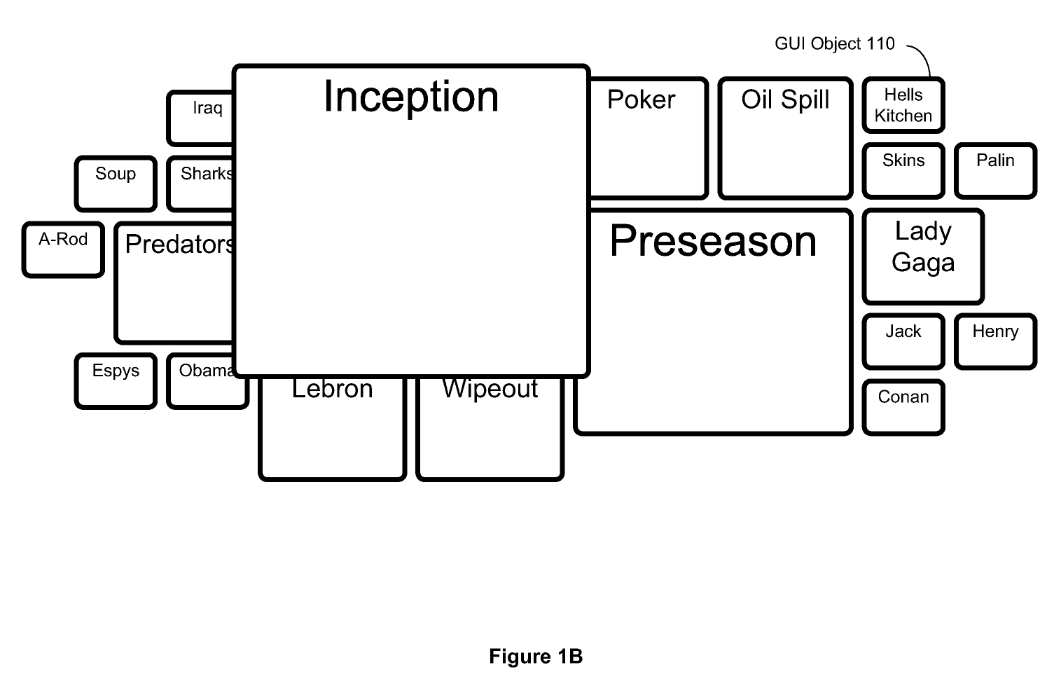

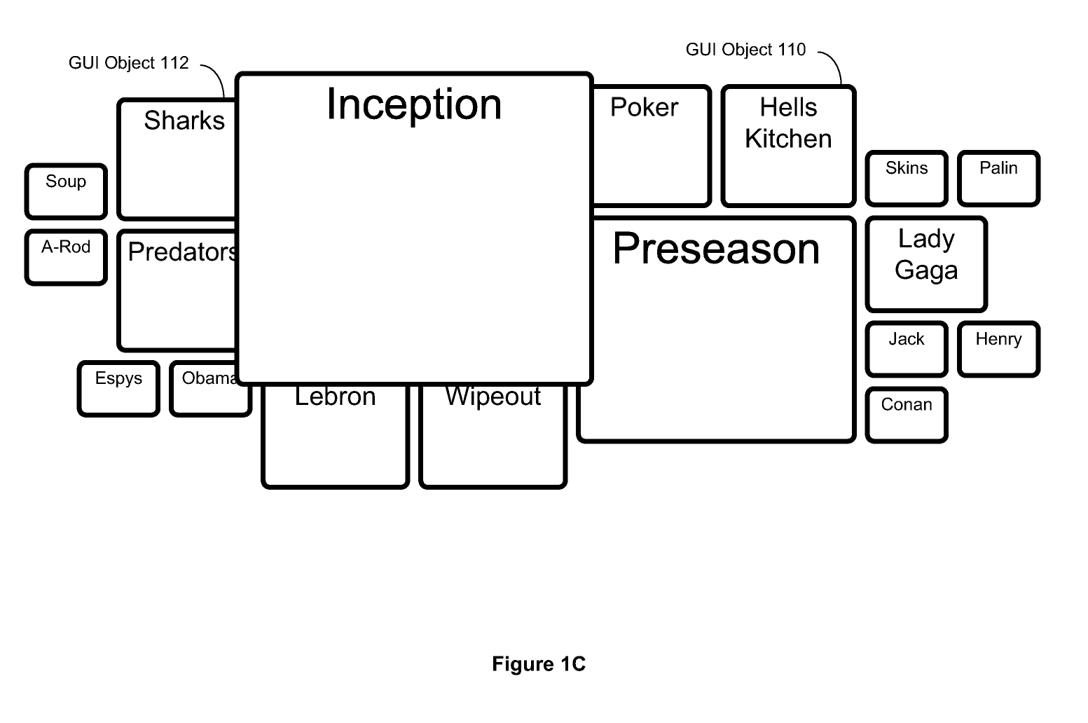

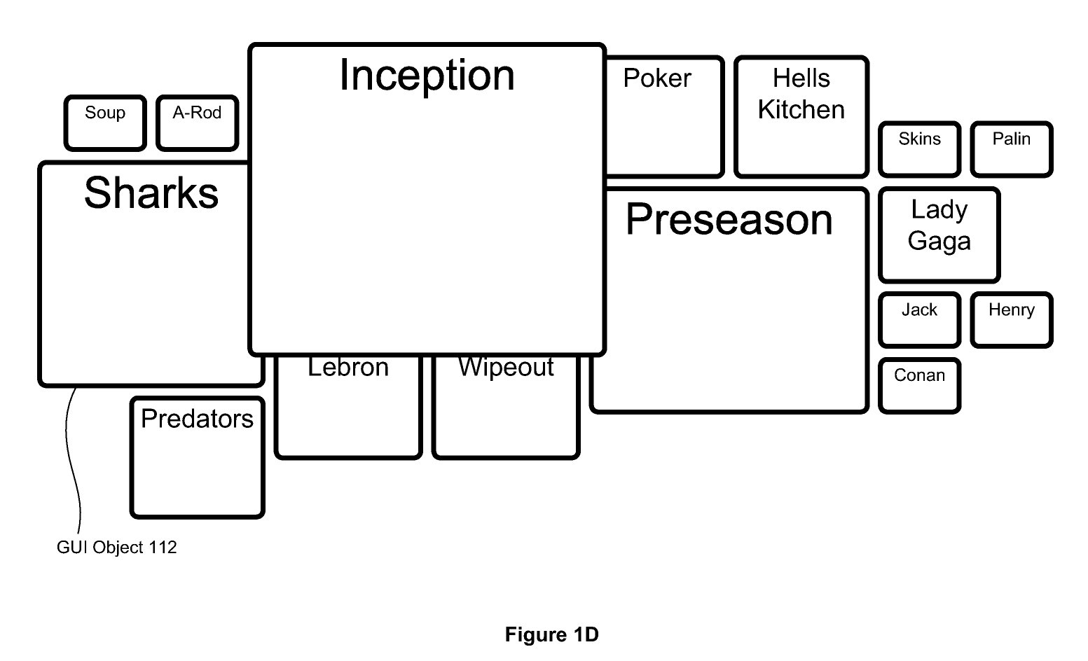

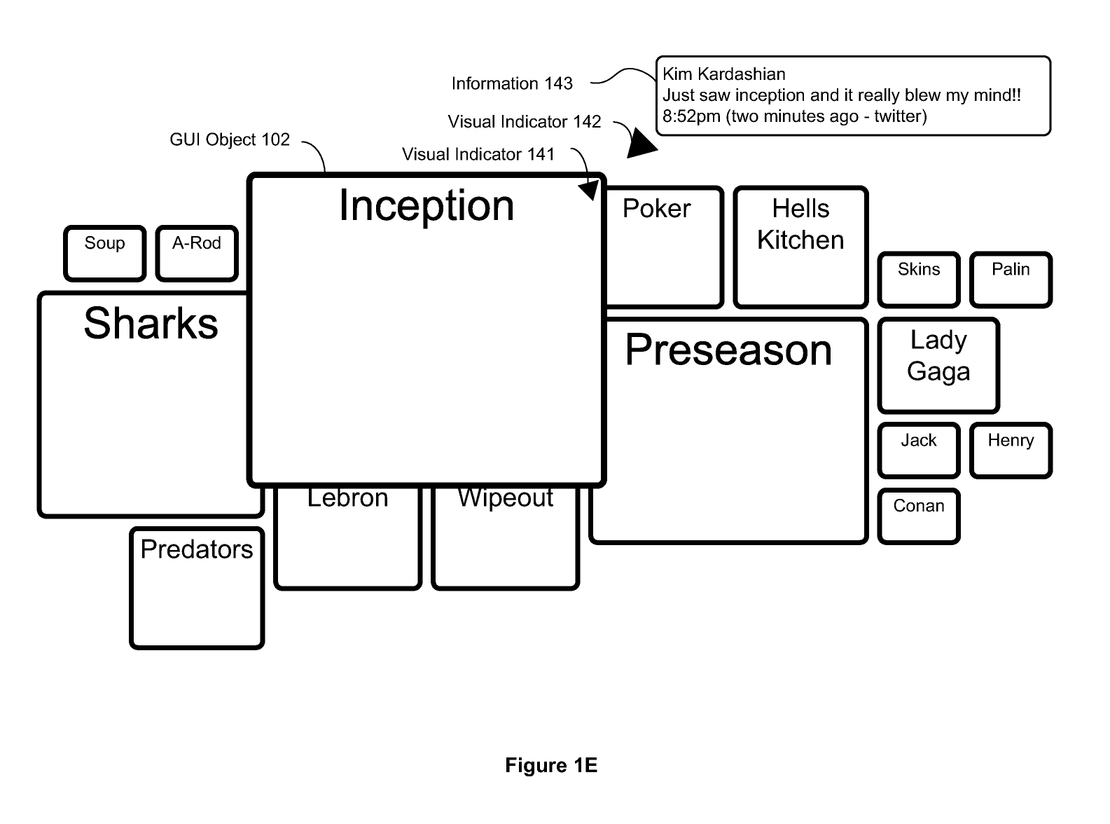

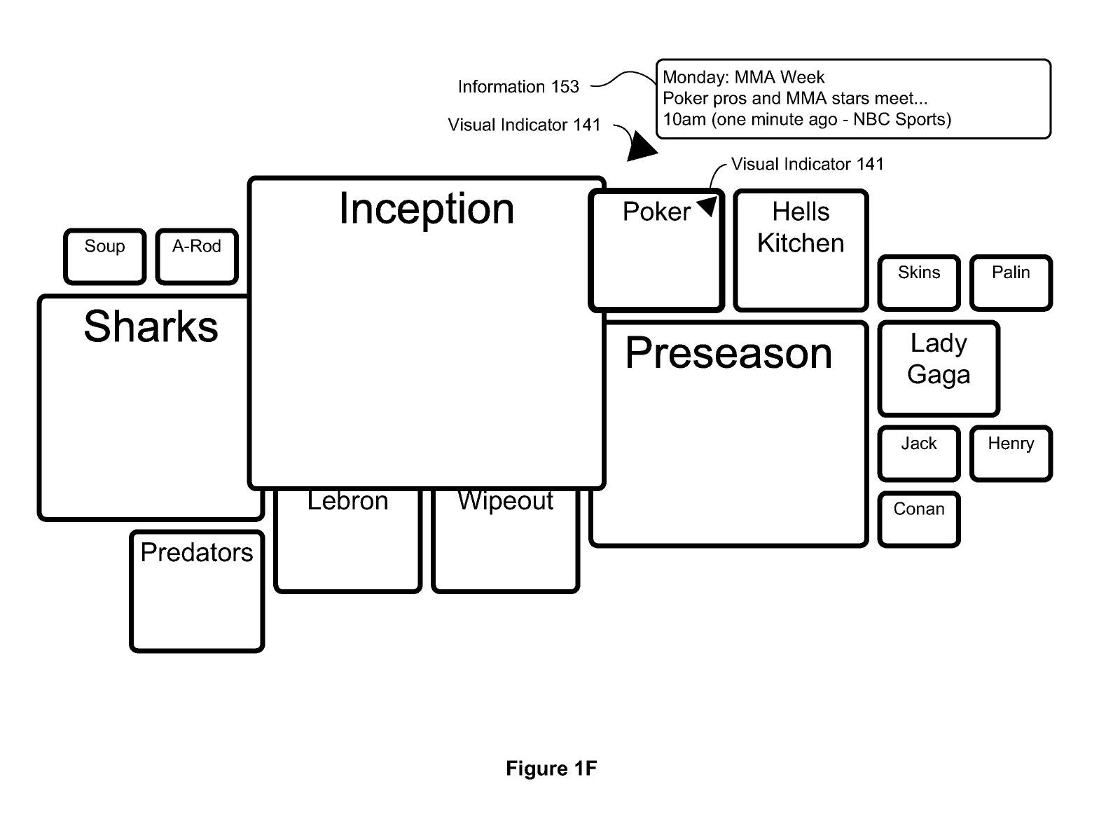

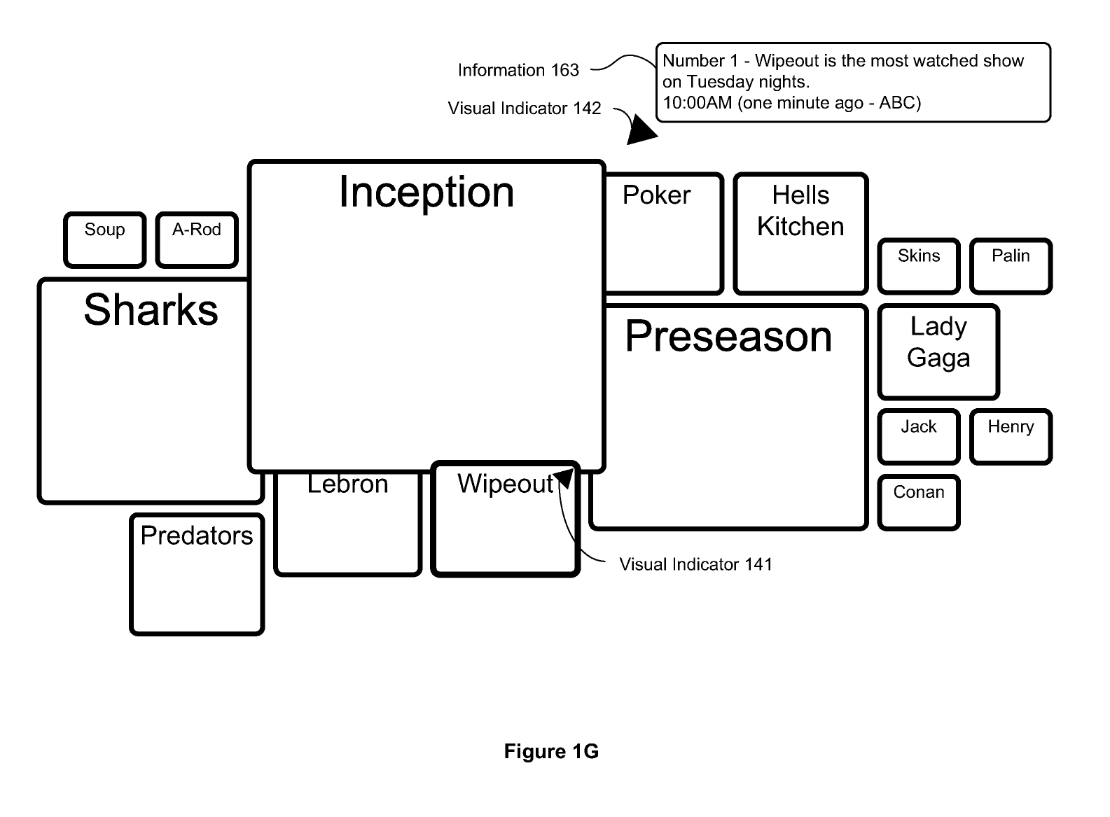

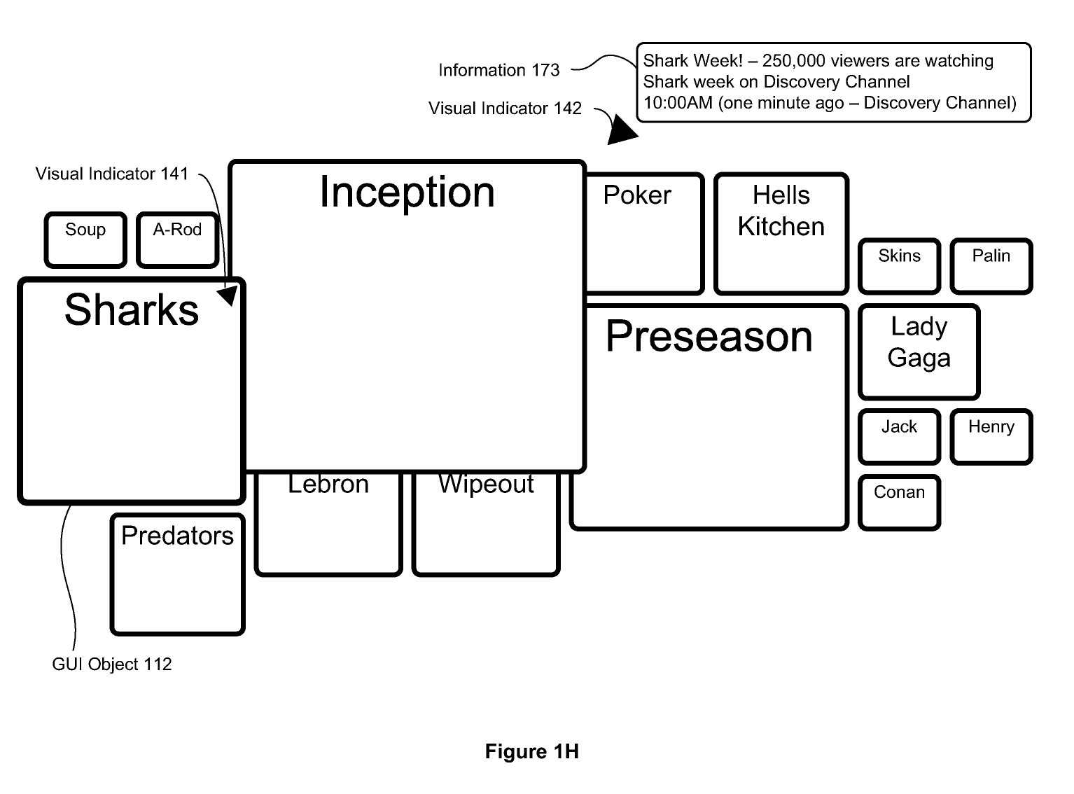

FIG. 1A-1I are block diagrams illustrating an exemplary graphical user interface for displaying information relating to video programs, according to some embodiments. In some embodiments, a video program is selected from the group consisting of: a movie, a movie trailer, a television show, a commercial, a music video, and an animation.

FIG. 1A includes a number of GUI objects each of which relating to at least one video program. In some embodiments, a GUI object includes text corresponding to the at least one video program. For example, GUI object 102 corresponds to at least one video program related to the movie “Inception” (e.g., movie trailers, video commentaries, video movie reviews, etc., for the movie “Inception”), GUI object 104 corresponds to at least one video program related to the oil spills (e.g., news videos, documentary videos, etc., related to oil spills), and GUI object 106 corresponds to at least one video program related to preseason football (e.g., news videos, videos of player/coach interviews, video clips of plays, videos of games, etc., related to preseason football). The text corresponding to the at least one video program may be obtained from an electronic program guide, metadata associated with the at least one video program, tags or categories (e.g., supplied by users or content providers) associated with the at least one video program, keywords on a web page including the at least one video program, and the like.

In some embodiments, a GUI object includes an image corresponding to the at least one video program. For example, the GUI object 102 may include an image of a scene from the movie “Inception”, the GUI object 104 may include an image of an oil spill, and the GUI object 106 may include an image of football players. The images corresponding to the at least one video program may be obtained from the at least one video program (e.g., a frame of the at least one video program), an image on a web page including the at least one video program, an image supplied by a user or a content provider, and the like.

In some embodiments, a GUI object includes a video corresponding to the at least one video program. For example, the GUI object 102 may display and play at least a portion of the video from the movie “Inception”, the GUI object 104 may display and play at least a portion of the video of an oil spill from a television news report, and the GUI object 106 may display and play at least a portion video of a football game. In some embodiments, the video is a live video feed of a currently available video program. For example, the video for the GUI object 102 may be displaying a live video feed of the movie “Inception” as it is being broadcast on a cable television channel. Similarly, the video for the GUI object 106 may be displaying a live video feed of a live football game airing on ESPN. In some embodiments, the video is a video clip of the at least one video program. In these embodiments, the video clip is a portion of the at least one video that may be played in loops in a GUI object. For example, the video for the GUI object 102 may be displaying a movie trailer for the movie “Inception.” In contrast, the video for the GUI object 106 may be displaying a replay clip of a play in a football game.

In some embodiments, a GUI object includes a textual description corresponding to the at least one video. The textual description may include a source of the at least one video (e.g., a channel, a video streaming service, etc.), a description of the content of the at least one video, a playing time of the at least one video, and the like. For example, the textual description for the GUI object 102 may include a synopsis of the storyline for the movie “Inception.” Similarly, the textual description for the GUI object 104 may include a transcript of a video news report on an oil spill. In some embodiments, the length of the textual description depends on the size of the GUI object. For larger GUI objects, all or a substantial portion of the textual description is displayed in the GUI object. For smaller GUI objects, a portion of the textual description is displayed in the GUI object. When only a portion (or none) of the textual description can be displayed in the GUI object, a visual indicator (e.g., a button, a shape, a short piece of text) may be used to indicate that more textual information is available. When a user selects (e.g., clicks on, hovers over) the visual indicator, the additional textual information is displayed. For example, a new text box may be displayed or a scroll bar may be added to the GUI object so that the user can scroll to the additional textual information.

In some embodiments, the visual appearance of a GUI object relative to other GUI objects indicates the popularity of the at least one video program corresponding to the GUI object relative to other video programs. In some embodiments, the visual appearance of the GUI object includes one or more of a size of the GUI object, an amount of focus of the GUI object, a numeric indicator of the GUI object, and a shape of the GUI object. For example, the GUI object 102 is larger than the GUI object 106 and the GUI object 104. Thus, the at least one video program corresponding to the GUI object 102 is more popular than the at least one video programs corresponding to the GUI objects 104 and 106. Similarly, the GUI object 106 is larger than the GUI object 104. Thus, the at least one video program corresponding to the GUI object 106 is more popular than the at least one video program corresponding to the GUI object 104.

In some embodiments, the location at which a GUI object is displayed in the graphical user interface relative to other GUI objects indicate the popularity of the at least one video program corresponding to the GUI object relative to other video programs. In some embodiments, the location of the GUI object includes one or more of a perceived distance that the GUI object is from a user (e.g., represented by the overlaying of GUI objects on top of each other) and a distance that the respective object is from a center of the graphical user interface. For example, the GUI object 102 is located substantially in the center of the graphical user interface whereas the GUI objects 104 and 106 are located to the right side of the graphical user interface. Thus, the at least one video program corresponding to the GUI object 102 is more popular than the at least one video programs corresponding to the GUI objects 104 and 106. Moreover, the GUI object 102 is perceived to be closer than the GUI object 106 (e.g., the GUI object 102 overlaps the GUI object 106). Thus, the at least one video program corresponding to the GUI object 102 is more popular than the at least one video program corresponding to the GUI object 106.

Accordingly, the visual appearance of the GUI objects and/or the location at which the GUI objects are displayed in the graphical user interface allows the user to quickly identify the popular video programs. In some embodiments, a user interacts with the graphical user interface and the GUI objects described above in an active mode and/or a passive mode.

In some embodiments, a user interacts with the GUI objects in the passive mode. In these embodiments, the real-time data received from the plurality of data sources is used to periodically update the visual appearance of the GUI objects and/or the location at which the GUI objects are displayed in the graphical user interface. In doing so, real-time trends indicating the popularity of video programs can be observed in real time. For example, FIGS. 1A-1D illustrate the graphical user interface over a time period. As illustrated in FIG. 1B, a new GUI object 110 corresponding to “Hells Kitchen” appears in the graphical user interface, indicating that at least one video program related to “Hells Kitchen” is becoming popular. In FIG. 1C, the size (e.g., the visual appearance) of the GUI object 110 increases and the location of the GUI object 110 moves towards the center of the graphical user interface. These changes in the visual appearance and location of the GUI object 110 indicate to the user that “Hells Kitchen” is becoming increasingly popular. Also illustrated in FIG. 1C, the size and location of GUI object 112 corresponding to “Sharks” have changed, indicating that video programs corresponding the GUI object 112 is also becoming increasingly popular, whereas video programs corresponding to the “Espys” and “Obama” have become less popular and are no longer displayed in the graphical user interface. In FIG. 1D, the size of the GUI object 110 increases again, indicating that video programs corresponding to the GUI object 112 is continuing to become increasingly popular.

In some embodiments, the user interacts with the GUI objects in an active mode. As illustrated in FIG. 1E, the user has selected (or has moved a cursor over) the GUI object 102. Information 143 corresponding to the GUI object 102 is displayed. Visual indicators 141 and 142 may be displayed to indicate that the information 143 corresponds to the GUI object 102. The information 143 is obtained from at least one data source in the plurality of data sources. In this example, the information 143 originated from a social network (e.g., Twitter). In some embodiments, the information 143 is periodically updated using data from the at least one data source. For example, the information 143 may be updated to reflect other user comments on the movie “Inception” that are posted on other social networks (or from any of the other data sources). In FIG. 1F, the user has selected (or has moved a cursor over) the GUI object corresponding to “Poker”. Information 153 corresponding to “Poker” is displayed in the graphical user interface. Again, the information 153 is obtained from at least one data source in the plurality of data sources. In this example, the information 153 originated from NBC sports. Note that in selecting (or moving a cursor over) the GUI object corresponding to “Poker”, the GUI object corresponding to “Poker” has moved closer to the user. In other words, the GUI object corresponding to “Poker” is layered on top of other GUI objects. Alternatively, the visual appearance and/or location of the GUI object corresponding to “Poker” may remain unmodified even if the user selects (or moves a cursor over) the GUI object corresponding to “Poker.” In FIG. 1G, the user has selected (or has moved a cursor over) the GUI object corresponding to “Wipeout”. Accordingly, information 163 corresponding to “Wipeout” is displayed in the graphical user interface. In this example, the information 163 indicates a reason as to why “Wipeout” has a particular popularity metric (e.g., “Wipeout is the most watched show on Tuesday nights.”). In FIG. 1H, the user has selected (or has moved a cursor over) the GUI 112. Accordingly, information 173 corresponding to “Sharks” is displayed in the graphical user interface. Again, the information 173 indicates a reason as to why “Sharks” has a particular popularity metric (e.g., “250,000 viewers are watching Shark week on Discovery Channel.”). FIG. 1I illustrates the graphical user interface after the user has selected the GUI object 112. As illustrated in FIG. 1I, video programs corresponding to the GUI object 112 (e.g., “Sharks”) is displayed. For example, the video programs include “Lunchtime”, “Hammerheads”, “Shark Bites”, “Air Jaws”, and “Mythbusters”. Note that any number of video programs may be displayed to the user. In some embodiments, when a user selects a particular video program, the particular video program is played. In some embodiments, when a user selects a particular video program, the particular video program is recorded.

In some embodiments, the active and passive modes are used in combination. For example, while a user is navigating the GUI objects in the graphical user interface, the visual appearance and the location of the GUI objects are updated regularly. Thus, existing GUI objects may increase in size, change locations, disappear, etc., and new GUI objects may appear based on real-time data received from the plurality of data sources while the user is navigating through the displayed GUI objects.

FIGS. 2A-2D are block diagrams illustrating another graphical user interface for displaying information relating to video programs, according to some embodiments. As illustrated in FIG. 2A, GUI objects are displayed across several rows. A center row of the graphical user interface corresponds to a row in which a currently selected (or active) GUI object exists. The visual appearance of GUI objects in the center row may be modified to distinguish the center row from other rows. For example, as illustrated in FIG. 2A, the GUI objects in the center row are larger in size than the GUI objects in other rows. In some embodiments, GUI object include a numeric indicator corresponding to the popularity of the GUI object. For example, a GUI object 204 has a numeric indicator 206 indicating that the popularity metric is “31” for video programs corresponding to the GUI object 204. In some embodiments, the GUI object 204 includes user comments 201. The user comments may be obtained from data sources such as social networks, blogs, articles, web pages, and the like. In some embodiments, the user comments 201 are periodically updated. For example, FIG. 2B illustrates that the user comments 201 has been updated with user comments 202. As illustrated in FIG. 2B, in some embodiments, the GUI objects move left and/or right within the graphical user interface to cycle through displaying available video programs. In some embodiments, GUI objects in the center row are static. In these embodiments, the GUI objects in the center row only move when a user interacts with the GUI objects. For example, FIG. 2C illustrates the graphical user interface after the user has navigated to the GUI object corresponding to “Alice in Wonderland”. It is noted that the other rows may continue to move left and right as the user interacts with the GUI objects in the center row. FIG. 2D illustrates the graphical user interface after the user has navigated to the GUI object corresponding to “Mad Men” (e.g., the top row in FIGS. 2A to 2C). As illustrated in FIG. 2D, GUI objects from the top row are moved to the center row, and GUI objects in the former center row are moved to the bottom row. Furthermore, new GUI objects are populated in the top row and GUI objects from the former bottom row are removed.

Note that instead of operating using rows, that the graphical user interface illustrated in FIGS. 2A-2D may be operated using columns. Also note, any number of rows and columns may be displayed in the graphical user interface. Furthermore, note that the numeric indicators illustrated in FIGS. 2A-2D may also be used in the graphical user interface illustrated in FIGS. 1A-1I.

### System Architecture

As discussed above, real-time data may be obtained from a plurality of data sources. FIG. 3 is a block diagram illustrating exemplary data sources that provide information relating to video programs, according to some embodiments. As illustrated in FIG. 3, a plurality of data sources, such as social networks 302, search engines 304, gaming networks 306, set top boxes 308, video streaming services 310, and video download services 312, are coupled to a network 350. Network 350 can generally include any type of wired or wireless communication channel capable of coupling together computing nodes. This includes, but is not limited to, a local area network, a wide area network, or a combination of networks. In some embodiments, network 350 includes the Internet.

In some embodiments, the plurality of data sources provide real-time data relating to video programs to a real-time data aggregator 320 via network 350. The real-time data aggregator 320 may be any type of computer system (e.g., a server) and may include any number of computer systems (e.g., a plurality of servers). In these embodiments, the real-time data aggregator 320 generates a real-time popularity metric for each video program and transmits the real-time popularity metric to computer systems 330. The computer systems 330 may include any type of computer system, including, but not limited to, a laptop computer system, a desktop computer system, a mobile phone, a portable gaming system, a gaming system, a portable electronic devices, and a set top box.

In some embodiments, the data sources provide real-time data relating to video programs directly to the computer systems 330 via network 350. In these embodiments, the computer systems 330 use the real-time data to calculate the real-time popularity metrics for the video programs.

Note that the following discussion assumes that the real-time popularity metrics are aggregated and calculated by a computer system 330. However, as described above, the computer system 330 may receive popularity metrics from the real-time data aggregator 320.

FIG. 4 is a block diagram illustrating a computer system 330 for displaying information relating to video programs in a graphical user interface, according to some embodiments. The computer system 330 typically includes one or more processing units (CPU's) 402, one or more network or other communications interfaces 404, memory 410, and one or more communication buses 409 for interconnecting these components. The communication buses 409 may include circuitry (sometimes called a chipset) that interconnects and controls communications between system components. The computer system 330 optionally may include a user interface 405 comprising a display device 406 and input devices 408 (e.g., keyboard, mouse, touch screen, keypads, etc.). Memory 410 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 410 may optionally include one or more storage devices remotely located from the CPU(s) 402. Memory 410, or alternately the non-volatile memory device(s) within memory 410, comprises a computer readable storage medium. In some embodiments, memory 410 stores the following programs, modules and data structures, or a subset thereof:
an operating system 412 that includes procedures for handling various basic system services and for performing hardware dependent tasks;
a communication module 414 that is used for connecting the computer system 330 to other computers via the one or more communication interfaces 404 (wired or wireless) and one or more communication networks, such as the Internet, other wide area networks, local area networks, metropolitan area networks, and so on;
a user interface module 416 that receives commands from the user via the input devices 408 and generates user interface objects 422, as described herein, in the display device 406, and receives real-time data 418 from a plurality of data sources that is used to calculate popularity metrics 420; and
video programs 424 (e.g., recorded or buffered video programs).

Each of the above identified elements may be stored in one or more of the previously mentioned memory devices, and corresponds to a set of instructions for performing a function described above. The set of instructions can be executed by one or more processors (e.g., the CPUs 404). The above identified modules or programs (e.g., sets of instructions) need not be implemented as separate software programs, procedures or modules, and thus various subsets of these modules may be combined or otherwise re-arranged in various embodiments. In some embodiments, memory 410 may store a subset of the modules and data structures identified above. Furthermore, memory 410 may store additional modules and data structures not described above.

Although FIG. 4 shows a “computer system,” FIG. 4 is intended more as functional description of the various features which may be present in a computer systems than as a structural schematic of the embodiments described herein. In practice, and as recognized by those of ordinary skill in the art, items shown separately could be combined and some items could be separated.

### Displaying Information Relating to Video Programs

The following discussion describes exemplary methods for displaying information relating to video programs and refers to a computer system 330 performing the following methods (or a subset thereof).

FIG. 5 is a flowchart of a method 500 for displaying information relating to video programs in a graphical user interface, according to some embodiments. The computer system 330 receives (502) real-time data for video programs from a plurality of data sources. Next, the computer system 330 determines (504) a real-time popularity metric for each video program based on the real-time data. For at least a subset of the video programs, the computer system 330 then displays (506) a respective graphical user interface object that corresponds to at least one respective video program in the subset of the video programs based on a respective real-time popularity metric for the at least one respective video program, wherein a location at which the respective graphical user interface object is displayed in the graphical user interface relative to other graphical user interface objects and a visual appearance of the respective graphical user interface object relative to other graphical user interface objects indicate the popularity of the at least one respective video program relative to other video programs.

In some embodiments, the visual appearance of the respective graphical user interface object includes a size of the respective graphical user interface object relative to other graphical user interface objects. In some embodiments, when the respective graphical user interface object for the at least one respective video program is larger than a second graphical user interface object corresponding to a second video program, the at least one respective video program is more popular than the second video program.

In some embodiments, the visual appearance of the respective graphical user interface object includes an amount that the respective graphical user interface object is in focus. In some embodiments, when the respective graphical user interface object for the at least one respective video program is more in focus (e.g., less blurry) than a second graphical user interface object corresponding to a second video program, the at least one respective video program is more popular than the second video program.

In some embodiments, the location of the respective graphical user interface object includes a perceived distance that the respective graphical user interface object is from a user. In some embodiments, when the respective graphical user interface object for the at least one respective video program is perceived to be closer to the user than a second graphical user interface object corresponding to a second video program, the at least one respective video program is more popular than the second video program.

In some embodiments, the location of the respective graphical user interface object includes a distance that the respective graphical user interface object is from a center of the graphical user interface. In some embodiments, when the respective graphical user interface object for the at least one respective video program is closer to the center of the graphical user interface than a second graphical user interface object corresponding to a second video program, the at least one respective video program is more popular than the second video program.

In some embodiments, the visual appearance of the respective graphical user interface object includes a numeric indicator corresponding to the popularity of the at least one respective video program relative to other video programs. In some embodiments, when the respective graphical user interface object for the respective program includes a numeric indicator that is larger in value than a number indicator for a second graphical user interface object corresponding to a second video program, the at least one respective video program is more popular than the second video program.

Returning to FIG. 5, in some embodiments, the computer system 330 periodically receives (508) updated real-time data for the video programs from the plurality of data sources and periodically updates (510) the graphical user interface objects based on the updated real-time data for the video programs.

Attention is now directed to FIG. 6, which is a flowchart of a method 600 for displaying information relating reasons why a selected video program has a particular popularity metric, according to some embodiments. The computer system 330 receives (602), from a user, a selection of a graphical user interface object being displayed in the graphical user interface and displays (604) information relating to reasons why a video program corresponding to the graphical user interface object has a particular popularity metric. Note that the term “selection” as used in this specification is used to refer to either a user activating a particular GUI object (e.g., by moving a cursor over the particular GUI object without clicking on it) or a user clicking on a particular GUI object.

FIG. 7 is a flowchart of a method 700 for displaying detailed information relating a selected video program, according to some embodiments. The computer system 330 receives (702), from a user, a selection of a graphical user interface object being displayed in the graphical user interface and displays (704) detailed information relating to a video program corresponding to the graphical user interface object.

FIG. 8 is a flowchart of a method 800 for playing a selected video program, according to some embodiments. The computer system 330 receives (802), from a user, a selection of a graphical user interface object being displayed in the graphical user interface and plays (804) a video program corresponding to the graphical user interface object.

FIG. 9 is a flowchart of a method 900 for recording a selected video program, according to some embodiments. The computer system 330 receives (902), from a user, a selection of a graphical user interface object being displayed in the graphical user interface and records (904) a video program corresponding to the graphical user interface object.

FIG. 10 is a flowchart of a method 1000 for displaying video programs related to a selected video program, according to some embodiments. The computer system 330 receives (1002), from a user, a selection of a graphical user interface object being displayed in the graphical user interface and displays (1004) graphical user interface objects corresponding to video programs related to the video program corresponding to the graphical user interface object.

In some embodiments, only GUI objects corresponding to video programs obtained from a particular video source is displayed in the graphical user interface. In these embodiments, a user may filter out video programs based on the video source. For example, a user may only wish to view video programs available on a video streaming service (e.g., YouTube). FIG. 11 is a flowchart of a method 1100 for displaying video programs from a particular video source, according to some embodiments. The computer system 330 displays (1102) tabs in the graphical user interface corresponding to video sources. For a respective tab corresponding to a respective video source, the computer system 330 only displays (1104) graphical user interface objects for corresponding video programs that are available from the respective video source. When a user clicks on another tab, the computer system 330 displays the video programs that are available on the corresponding video source. In some embodiments, the respective video source is selected from the group consisting of: a cable television video feed, a satellite television video feed, an over-the-air television video feed, and an Internet video feed.

The methods discussed with respect to FIGS. 5-11 may be governed by instructions that are stored in a computer readable storage medium and that are executed by one or more processors of one or more servers. Each of the operations shown in FIG. 5-11 may correspond to instructions stored in a computer memory or computer readable storage medium. The computer readable storage medium may include a magnetic or optical disk storage device, solid state storage devices such as Flash memory, or other non-volatile memory device or devices. The computer readable instructions stored on the computer readable storage medium are in source code, assembly language code, object code, or other instruction format that is interpreted and/or executable by one or more processors.

Certain embodiments are described herein as including instructions, logic, or a number of components, modules, or mechanisms. Modules may constitute either software modules (e.g., code or instructions embodied on a computer-readable storage medium) or hardware modules. A hardware module is a tangible unit capable of performing certain operations and may be configured or arranged in a certain manner. In some embodiments, one or more computer systems (e.g., the computer system 330) or one or more hardware modules of a computer system (e.g., a processor 402 or a group of processors) may be configured by software (e.g., an application or application portion) as a hardware module that operates to perform certain operations as described herein.

In some embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor 402 or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 402 configured using software, the general-purpose processor 402 may be configured as respective different hardware modules at different times. Software may accordingly configure a processor 402, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors 402 that are temporarily configured (e.g., by software) or permanently configured to perform the relevant operations. Whether temporarily or permanently configured, such processors 402 may constitute processor-implemented modules that operate to perform one or more operations or functions. The modules referred to herein may, in some example embodiments, comprise processor-implemented modules.

Similarly, the methods described herein may be at least partially computer-implemented. For example, at least some of the operations of a method may be performed by one or more processors 402 or processor-implemented modules. The performance of certain of the operations may be distributed among the one or more processors 402, not only residing within a single machine, but deployed across a number of machines. In some example embodiments, the processors 402 may be located in a single location (e.g., within a home environment, an office environment or as a server farm), while in other embodiments, the processors 402 may be distributed across a number of locations.

Note that although the embodiments described herein refer to video programs, the embodiments described herein may be applied to any type of media object. In some embodiments, a media object is selected from the group consisting of video, audio, text, an image, and a combination thereof (e.g., multimedia).

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method for displaying information relating to video programs in a graphical user interface, comprising:
at a computer system including at least one processor and memory storing at least one program, the at least one processor executing the at least one program to perform the operations of:
receiving real-time data for video programs from a plurality of data sources;
determining a real-time popularity metric for each video program based on the real-time data; and
for at least a subset of the video programs, displaying a respective graphical user interface object that corresponds to at least one respective video program in the subset of the video programs based on a respective real-time popularity metric for the at least one respective video program, wherein a location at which the respective graphical user interface object is displayed in the graphical user interface relative to other graphical user interface objects and a visual appearance of the respective graphical user interface object relative to other graphical user interface objects indicate the popularity of the at least one respective video program relative to other video programs.

2. The method of claim 1, wherein the visual appearance of the respective graphical user interface object includes a size of the respective graphical user interface object relative to other graphical user interface objects.

3. The method of claim 2, wherein when the respective graphical user interface object for the at least one respective video program is larger than a second graphical user interface object corresponding to a second video program, the at least one respective video program is more popular than the second video program.

4. The method of claim 1, wherein the visual appearance of the respective graphical user interface object includes an amount that the respective graphical user interface object is in focus.

5. The method of claim 4, wherein when the respective graphical user interface object for the at least one respective video program is more in focus than a second graphical user interface object corresponding to a second video program, the at least one respective video program is more popular than the second video program.

6. The method of claim 1, wherein the location of the respective graphical user interface object includes a perceived distance that the respective graphical user interface object is from a user.

7. The method of claim 6, wherein when the respective graphical user interface object for the at least one respective video program is perceived to be closer to the user than a second graphical user interface object corresponding to a second video program, the at least one respective video program is more popular than the second video program.

8. The method of claim 1, wherein the location of the respective graphical user interface object includes a distance that the respective graphical user interface object is from a center of the graphical user interface.

9. The method of claim 8, wherein when the respective graphical user interface object for the at least one respective video program is closer to the center of the graphical user interface than a second graphical user interface object corresponding to a second video program, the at least one respective video program is more popular than the second video program.

10. The method of claim 1, wherein the visual appearance of the respective graphical user interface object includes a numeric indicator corresponding to the popularity of the at least one respective video program relative to other video programs.

11. The method of claim 10, wherein when the respective graphical user interface object for the respective program includes a numeric indicator that is larger in value than a number indicator for a second graphical user interface object corresponding to a second video program, the at least one respective video program is more popular than the second video program.

12. The method of claim 1, further comprising:
periodically receiving updated real-time data for the video programs from the plurality of data sources; and
periodically updating the graphical user interface objects based on the updated real-time data for the video programs.

13. The method of claim 1, wherein a video program is selected from the group consisting of:
a movie;
a movie trailer;
a television show;
a commercial;
a music video; and
an animation.

14. The method of claim 1, wherein a data source is selected from the group consisting of:
a social network;
a gaming network;
a search engine;
a set top box;
a video streaming service; and
a video download service.

15. The method of claim 1, further comprising:
receiving, from a user, a selection of a graphical user interface object being displayed in the graphical user interface; and
displaying information relating to reasons why a video program corresponding to the graphical user interface object has a particular popularity metric.

16. The method of claim 1, further comprising:
receiving, from a user, a selection of a graphical user interface object being displayed in the graphical user interface; and
displaying detailed information relating to a video program corresponding to the graphical user interface object.

17. The method of claim 1, further comprising:
receiving, from a user, a selection of a graphical user interface object being displayed in the graphical user interface; and
playing a video program corresponding to the graphical user interface object.

18. The method of claim 1, further comprising:
receiving, from a user, a selection of a graphical user interface object being displayed in the graphical user interface; and
recording a video program corresponding to the graphical user interface object.

19. The method of claim 1, further comprising:
receiving, from a user, a selection of a graphical user interface object being displayed in the graphical user interface; and
displaying graphical user interface objects corresponding to video programs related to the video program corresponding to the graphical user interface object.

20. The method of claim 1, further comprising:
displaying tabs in the graphical user interface corresponding to video sources; and
for a respective tab corresponding to a respective video source, only displaying graphical user interface objects for corresponding video programs that are available from the respective video source.

21. The method of claim 20, wherein the respective video source is selected from the group consisting of:
a cable television video feed;
a satellite television video feed;
an over-the-air television video feed; and
an Internet video feed.

22. A graphical user interface on a computer system including at least one processor and memory storing at least one program, the at least one processors configured to execute the at least one program, wherein the graphical user interface comprises:
a plurality of graphical user interface objects displayed in the graphical user interface of the computer system, wherein a respective graphical user interface object corresponds to at least one respective video program, wherein a location at which the respective graphical user interface object is displayed in the graphical user interface relative to other graphical user interface objects and a visual appearance of the respective graphical user interface object relative to other graphical user interface objects is based on a popularity metric that indicates the popularity of the at least one respective video program relative to other video programs, wherein the popularity metric of the at least one respective video program is determined from real-time data for the video programs that are received from plurality of data sources.

23. A system for displaying information relating to video programs in a graphical user interface, comprising:
at least one processor;
memory; and
at least one program stored in the memory, the at least one program comprising instructions to:
receive real-time data for video programs from a plurality of data sources;
determine a real-time popularity metric for each video program based on the real-time data; and
for at least a subset of the video programs, display a respective graphical user interface object that corresponds to at least one respective video program in the subset of the video programs based on a respective real-time popularity metric for the at least one respective video program, wherein a location at which the respective graphical user interface object is displayed in the graphical user interface relative to other graphical user interface objects and a visual appearance of the respective graphical user interface object relative to other graphical user interface objects indicate the popularity of the at least one respective video program relative to other video programs.

24. A computer readable storage medium storing at least one program configured for execution by a computer, the at least one program comprising instructions to:
receive real-time data for video programs from a plurality of data sources;
determine a real-time popularity metric for each video program based on the real-time data; and
for at least a subset of the video programs, display a respective graphical user interface object that corresponds to at least one respective video program in the subset of the video programs based on a respective real-time popularity metric for the at least one respective video program, wherein a location at which the respective graphical user interface object is displayed in the graphical user interface relative to other graphical user interface objects and a visual appearance of the respective graphical user interface object relative to other graphical user interface objects indicate the popularity of the at least one respective video program relative to other video programs.

25. A computer-implemented method for displaying information relating to media objects in a graphical user interface, comprising:
at a computer system including at least one processor and memory storing at least one program, the at least one processor executing the at least one program to perform the operations of:
receiving real-time data for media objects from a plurality of data sources;
determining a real-time popularity metric for each media object based on the real-time data; and
for at least a subset of the media objects, displaying a respective graphical user interface object that corresponds to at least one respective media object in the subset of the media objects based on a respective real-time popularity metric for the at least one respective media object, wherein a location at which the respective graphical user interface object is displayed in the graphical user interface relative to other graphical user interface objects and a visual appearance of the respective graphical user interface object relative to other graphical user interface objects indicate the popularity of the at least one respective media object relative to other media objects.

26. The method of claim 25, wherein the at least one respective media object is selected from the group consisting of:
video;
audio;
text; and
an image.

27. A system for displaying information relating to media objects in a graphical user interface, comprising:
at least one processor;
memory; and
at least one program stored in the memory, the at least one program comprising instructions to:
receive real-time data for media objects from a plurality of data sources;
determine a real-time popularity metric for each media object based on the real-time data; and
for at least a subset of the media objects, display a respective graphical user interface object that corresponds to at least one respective media object in the subset of the media objects based on a respective real-time popularity metric for the at least one respective media object, wherein a location at which the respective graphical user interface object is displayed in the graphical user interface relative to other graphical user interface objects and a visual appearance of the respective graphical user interface object relative to other graphical user interface objects indicate the popularity of the at least one respective media object relative to other media objects.

28. A computer readable storage medium storing at least one program configured for execution by a computer, the at least one program comprising instructions to:
receive real-time data for media objects from a plurality of data sources;
determine a real-time popularity metric for each media object based on the real-time data; and
for at least a subset of the media objects, display a respective graphical user interface object that corresponds to at least one respective media object in the subset of the media objects based on a respective real-time popularity metric for the at least one respective media object, wherein a location at which the respective graphical user interface object is displayed in the graphical user interface relative to other graphical user interface objects and a visual appearance of the respective graphical user interface object relative to other graphical user interface objects indicate the popularity of the at least one respective media object relative to other media objects.

29. A graphical user interface on a computer system including at least one processor and memory storing at least one program, the at least one processors configured to execute the at least one program, wherein the graphical user interface comprises:
a plurality of graphical user interface objects displayed in the graphical user interface of the computer system, wherein a respective graphical user interface object corresponds to at least one respective media object, wherein a location at which the respective graphical user interface object is displayed in the graphical user interface relative to other graphical user interface objects and a visual appearance of the respective graphical user interface object relative to other graphical user interface objects is based on a popularity metric that indicates the popularity of the at least one respective media object relative to other media objects, wherein the popularity metric of the at least one respective media object is determined from real-time data for the media objects that are received from plurality of data sources.
